(19) United States
(12) Patent Application Publication
(10) Pub. No.: US 2017/0064921 A1
(43) Pub. Date: Mar. 9, 2017

(54) Hide a Scooper

(71) Applicant: Tony Espinosa, Virginia Beach, VA (US)

(72) Inventor: Tony Espinosa, Virginia Beach, VA (US)

(21) Appl. No.: 14/844,732

(22) Filed: Sep. 3, 2015

(51) Int. Cl. A01K 1/01

(52) U.S. Cl. CPC A01K 1/01

(57) ABSTRACT

This invention relates to a device made from recycled plastic material that houses the entire pooper-scooper used for the retrieval of animal feces from any surface. The container is filled with cat litter at its bottom. The device is open to place the scooper inside after the retrieval of animal feces. It keeps the area odor free, and also cleans the scooper's blade with cat litter.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) Field of the Invention

The present invention generally relates to the field of animal feces disposal devices. In particular, the invention relates to a device for animal feces disposition from blades of pooper-scoopers that is easy to clean and keeps the device and surroundings odor free.

(2) Background of the Invention

The present invention relates to a device for the disposition of animal feces, and, in particular, to disposition of animal feces from the blades of pooper-scoopers. The invention also relates to an absorbent material that is put inside of the device and is located at bottom of the device. The absorbent material absorbs animal urine and moisture from animal feces. This absorbent material is commonly called cat litter. The cat litter serves as a medium to dispose of the animal feces from blades of pooper-scoopers without the use of hands.

Previously, there have been many devices that provide for collection and disposal of animal feces, such as shovels, forceps. etc. A pooper-scooper is one such device. The pooper-scooper normally has two openings. One opening has blades for collection of animal feces from a surface, and the second opening has a disposable bag attached to it. Such devices prevent direct contact with feces and keep the collection process more sanitary. However, in the process of the collection of animal waste, such devices come in contact with the feces, if the device is not a disposable type, the device must then be cleaned. The present disclosure provides a way to clean the blades of the pooper-scooper without using hands.

U.S. Pat. No. 8,066,311 B2, assigned to T. F. H. Publications, Inc., is directed towards a method of providing a pooper-scooper with a surface that is relatively easy to clean. The method includes providing a pooper-scooper that has a scoop anchor rake portion that may interface with animal feces. The scoop and/or rake portion has a surface that is coated with a coating, where at least a portion of the surface of the scoop and/or rake portion includes a coating, and where the coating exhibits a coefficient of friction (μ) of less than or equal to 1.0 and a contact anile of 90° or greater relative to animal waste.

Such devices may have the purpose of preventing any contact directly with the feces. However, in the process of cleaning up animal waste, such devices, as noted above, may come in contact with the feces. In the long run, the feces will start depositing on the surface of scoop or rake portion due to removal of coating resulting from continuous usage of the scooper. Also, solid feces may be so rigid that it is not easy to remove from the surface of scoop and/or rake, and device must be cleaned by hands.

U.S. Pat. No. 4,723,510 A, assigned to Litter screen, Inc., is directed towards a device to facilitate the removal of animal feces from a litter box, in which the device is disposed and upon which is placed cat litter. The device is comprised of a plurality of semi-rigid sheets or films, all but one of which has a series of perforations on them. The perforations have size so as to permit the sifting of cat litter, but are adapted to not let the feces pass through them. The feces can be removed merely by lifting the film from the litter box.

Such devices may serve the purpose of easy removal of animal feces. However, in the process of cleaning up such animal waste, such devices will require usage of hands, and may result in the spoiling of hands while removing the rigid sheets or films. Also, such perforated semi-rigid films may be costly for regular use.

Thus, there is a long felt need for a self-cleaning device. The current invention provides a device that tries to overcome the drawbacks of prior arts mentioned above by providing a container to house pooper-scooper that is filled with animal cat litter to clean the blades of the pooper-scooper.

### SUMMARY OF THE INVENTION

In the view of the foregoing disadvantages inherent in the known types of devices that provide an easy way to clean animal feces from pooper-scoopers now present in the prior art, the present invention provides an improved device to dean animal feces from the blades of poop-scoopers. As such, the general purpose of the present invention, which will be described subsequently in greater detail, is to provide a new and improved device to dean animal feces from the blade of poop scoopers that has all of the advantages of the prior art, and none of the disadvantages.

An objective of the invention is to provide a device for cleaning the blades of pooper-scoopers used for collection of animal feces from any surface.

It is another objective of the present invention to provide a device for cleaning the blades of pooper-scoopers with using hands.

It is another objective of the present invention to provide a device for cleaning the blades of pooper-scoopers that is self-cleaning.

It is another objective of the present invention to provide a device for cleaning the blades of pooper-scoopers that helps keep the device and surroundings odor free.

It is another objective of the present invention to provide a device for cleaning the blades of pooper-scoopers that is not costly.

in this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of description, and should not be regarded as limiting.

These, together with other objectives of the invention and the various features of novelty that characterize the invention, are pointed out with particularity in the disclosure. For a better understanding of the invention, its operating advantages, and the specific objectives attained by its uses, reference should be had to the accompanying drawings and descriptive matter, in which there are illustrated preferred embodiments of the invention.

### BRIEF DESCRIPTION OF THE DRAWINGS

To further clarify various aspects of some example embodiments of the present invention, a more particular description of the invention will be rendered by reference to specific embodiments thereof; which are illustrated in the appended drawing. It is appreciated that the drawing depicts only illustrated embodiments of the invention and is, therefore, not to be considered limiting of its scope. The invention will be described and explained with additional specificity and detail through the use of the accompanying drawing, in which:

FIG. 1 is an isometric front view of the device.

FIG. 2 is an isometric back view of the device.

### DETAILED DESCRIPTION OF THE INVENTION

In the following detailed description, reference is made to the specific embodiments in which the invention may be practiced. These embodiments are described in sufficient detail to enable those skilled in the art to practice the invention. It is to be understood that the embodiments may be combined, or that other embodiments may be utilized, and that structural and logical changes may be made without departing from the spirit and scope of the present invention. The following detailed description is, therefore, not to be taken in a limiting sense, and the scope of the present invention is defined by the appended claims and their equivalents.

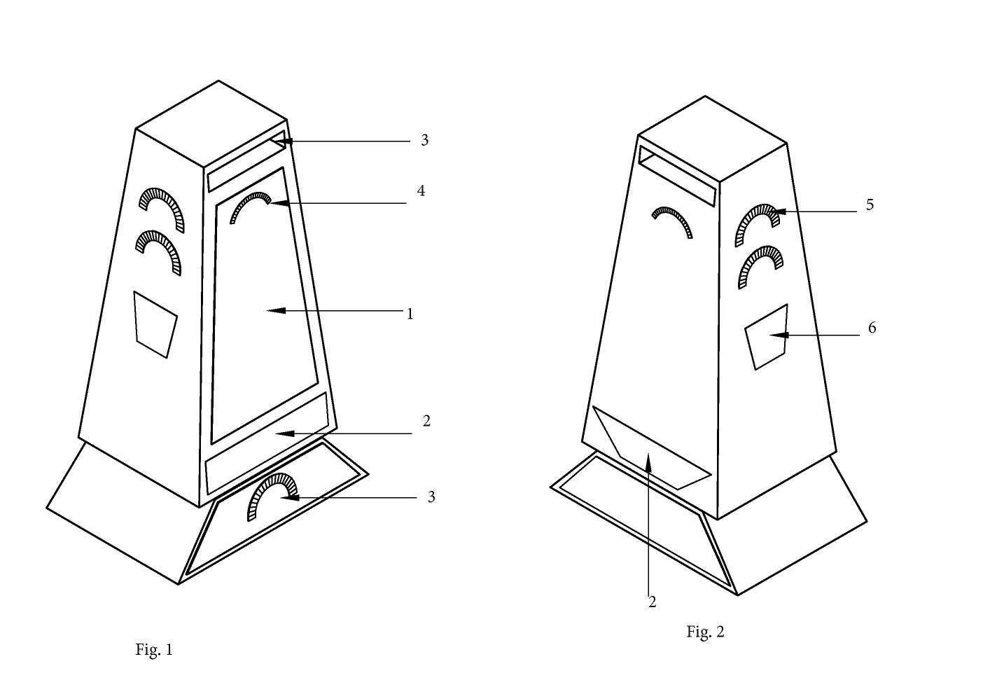

The present invention provides for a device for cleaning the blades of pooper-scoopers without coming in direct contact with animal feces and without using hands. The invention provides a container FIG. 1 and FIG. 2 such as a bucket, that is filled with cat litter. The container is provided with an enclosure or housing 31. The pooper-scooper is placed inside of the housing of the container and upon the cat litter after the collection of the animal feces has been performed with it. The cat litter has an intrinsic property of absorbing the moisture of the solid animal feces. The cat litter inside of the container 2 encloses the blades of the pooper-scooper in such a way that, upon removal of the pooper-scooper from the container. the animal feces stuck on the blades are removed. At the same time, the cat litter keeps the area odor free. The container has handles 3 to make it easy to move around, the handles 4 to open forward the cover of the container, and the handles to hook pet's leashes 5. The container also has a special pocket for holding plastic bags 6.

The present invention is great because of the way the blades of the pooper-scooper are cleaned both economically and efficiently. It is easy for any person to use this device without getting their hands dirty.

Advantageously, the present invention is different from the existing knowledge. Prior art provides coating, perforated films, etc. for keeping the surface of the scoop clean. Also, for the removal of such coating, perforated films etc. that are placed on the surface of the pooper-scooper, hands are required. Other inventions do not utilize the cat litter in such a efficient manner, where it removes animal feces from the blades of the pooper-scoopers, and also provides for an odor free area.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages that may be provided by the present invention have been described above with regard to specific embodiments. These benefits and advantages, and any elements or limitations that may cause them to occur or to become more pronounced, are not to be construed as critical, required, or essential features of any or all of the embodiments.

While the present invention has been described with reference to particular embodiments, it should be understood that the embodiments are illustrative, and that the scope of the invention is not limited to these embodiments. Many variations, modifications, additions, and improvements to the embodiments described, above are possible. It is contemplated that these variations, modifications, additions, and improvements fall within the scope of the invention.

I claim:

1. A device for the disposition of animal feces from a pooper-scooper, comprising:
an enclosure; and
an absorbent material filled at the bottom.

2. The device for the disposition of animal feces from a pooper-scooper, according to claim 1, wherein said device is a container.

3. The device for the disposition of animal feces from a pooper-scooper, according to claim 1, wherein said device for the disposition of animal feces from said pooper-scooper is made of recycled plastic material.

4. The device for the disposition of animal feces from a pooper-scooper, according to claim 1, wherein said enclosure houses said pooper-scooper.

5. The device for the disposition of animal feces from a pooper-scooper, according to claim 1, therein said absorbent material filed at bottom is cat litter.

6. The device for the disposition of animal feces from a pooper-scooper, according to claim 1, wherein said absorbent material filled at bottom of said container absorbs the urine and moisture from animal feces.

7. The device for the disposition of animal feces from a pooper-scooper, according to claim 1, wherein said absorbent material filled at bottom or said container helps to keep the blades of said pooper-scooper clean.

8. The device for the disposition of animal feces from a pooper-scooper, according to claim 1, wherein said absorbent material filled at the bottom of said container helps to keep said container odor free.

9. A method for the disposition of animal feces from a pooper-scooper, comprising:
filing a device for the disposition of animal feces with an absorbent material at bottom;
placing a pooper-scooper inside of an enclosure inside the device for the disposition of animal feces; and
surrounding the blades of said pooper-scooper with said absorbent material for the removal of animal feces.

10. A method for the disposition of animal feces from a pooper-scooper, according to claim 9, wherein said device for the disposition of animal feces is a container.

11. A method for the disposition of animal feces from a pooper-scooper, according to claim 9, wherein said absorbent material is cat litter.

12. A method for the disposition of animal feces from a pooper-scooper, according to claim 9, wherein said enclosure is a housing.

13. A method for the disposition of animal feces from a pooper-scooper, according to claim 9, wherein said cat litter cleans the blades of said pooper-scooper.

14. A method for the disposition of animal feces from a pooper-scooper, according to claim 9, wherein said cat litter keeps the place odor free.
